(19) United States
(12) Patent Application Publication
(10) Pub. No.: US 2009/0195329 A1
(43) Pub. Date: Aug. 6, 2009

(54) VARIABLE PHASE SHIFTER

(75) Inventors: Duk-Yong Kim, Gyeonggi-do (KR); Young-Chan Moon, Gyeonggi-do (KR); Ryoji Matsubara, Gyeonggi-do (KR); Eui-Song Choi, Gyeonggi-do (KR); Nam-Il Kim, Gyeonggi-do (KR)

Correspondence Address: STORM LLP, BANK OF AMERICA PLAZA, 901 MAIN STREET, SUITE 7100, DALLAS, TX, 75202, US

(73) Assignee: KMW INC., Kyonggi-do, KR (KR)

(21) Appl. No.: 12/303,334

(22) PCT Filed: Jun. 19, 2007
(86) PCT No.: PCT/KR2007/002967

§ 371 Date: Dec. 3, 2008

(30) Foreign Application Priority Data
Jun. 19, 2006 (KR) 10-2006-0054836

(51) Int. Cl. H01P 1/18

(52) U.S. Cl. 333/161

(57) ABSTRACT

Disclosed is a variable phase shifter The variable phase shifter includes a housing; a fixed board unit fixedly installed inside the housing, equipped with an input microstrip line with a via hole for receiving an input signal on one face thereof, and equipped with at least one circular arc-shaped output microstrip line outside the input microstrip line; and a rotating board unit rotatably installed inside the housing while being in contact with the one face of the fixed board unit, equipped with a transmission microstrip line on a face coming in contact with the one face of the fixed board unit, and for providing at least one output signal by making coupling even during rotation thereof.

### TECHNICAL FIELD

The present invention relates to a variable phase shifter used for shifting a phase of an input signal to output a phase-shifted signal, and more particularly to a variable phase shifter capable of performing distribution of an input signal and varying the degree of phase shift.

### BACKGROUND ART

In general, communication equipment for linearly transmitting communication signals requires signal processors, such as a phase shifter for changing a phase of an input signal and an attenuator for attenuating the strength of an input signal by a given magnitude. The above phase shifter is used in widespread application fields. To cite one example of the application fields, the phase shifter provides Radio Frequency (RF) signals with phase shift selective to a signal required to propagate the RF signals. As is generally known, the phase shifter is adopted in various RF application fields, such as a phased array antenna system.

Especially, the variable phase shifter is used in such a field as an RF analog signal processor in order to perform the phase modulation function, including beam control of a phased array antenna. The principle of the variable phase shifter is to generate a phase difference between an input signal and an output signal by properly delaying the input signal, and may be embodied by simply varying the physical length of a transmission line, by varying the signal transfer rate within a transmission line in various ways, and so on. For example, by allowing the length of a transmission line to be able to change, etc., the phase shifter is commonly used in such a structure that the degree of phase shift can change.

Recently, a mobile communication system has demanded the technology of varying respective phases of radiating elements of a phased array antenna in an inter-harmonious manner in order to adjust a coverage area of a base station by controlling a vertical beam angle of the phased array antenna of the base station. Keeping pace with the above demands, phase shifters with various structures have been developed and spread. Particularly, each variable phase shifter may have a structure for distributing an input signal into a plurality of output signals, and for properly adjusting phase differences among the respective output signals. One example of the variable phase shifters all having the above structure is disclosed in “Radio-Frequency Phase Shift Assembly” filed in the Korean Industrial Property Office by Kathrein-Werke KG and assigned Serial No. 2002-7001916 (Inventors: Gottl, Maximilian), and in Korean Patent Registration No. 10-392130 (Title: “Phase Shifter Capable of Selecting Phase Shift Range” Inventors: Rak-Jun Baek and Seung-Chol Lee).

Meanwhile, since mobile communication technology has recently made rapid progress, and since RF signal processing technology responding to this has also demanded high performance, various researches are actively carried out so as to improve the performance of the variable phase shifter and to provide the variable phase shifter with a more efficient configuration.

### DISCLOSURE OF INVENTION

### Technical Problem

Accordingly, the present invention has been made to solve the above-mentioned problems occuring in the prior art, and it is an object of the present invention to provide a variable phase shifter having a more improved performance.

It is another object of the present invention to provide a variable phase shifter which can not only reduce an overall product size thereof but can also have a more stable mechanical structure.

### Technical Solution

In order to accomplish the above objects of the present invention, according to an aspect of the present invention, there is provided a variable phase shifter, including: a housing; a fixed board unit fixedly installed inside the housing, equipped with an input microstrip line with a via hole for receiving an input signal on one face thereof, and equipped with at least one circular arc-shaped output microstrip line outside the input microstrip line; and a rotating board unit rotatably installed inside the housing while being in contact with the one face of the fixed board unit, equipped with a transmission microstrip line on a face coming in contct with the one face of the fixed board unit, and for providing at least one output signal by making coupling even during rotation thereof.

### Advantageous Effects

A variable phase shifter according to the present invention distributes an input signal through a microstrip line coupling structure using a fixed board and a rotating board, and by producing length differences among multiple transmission lines, varies phases among signals provided through output ports, thereby allowing a reduction in the overall product size of the variable phase shifter. In addition, mechanical abrasions caused by a mechanical contact between strip lines can be reduced, and a more improved performance of the variable phase shifter can be attained.

### BRIEF DESCRIPTION OF THE DRAWINGS

The above and other aspects, features and advantages of the present invention will be more apparent from the following detailed description taken in conjunction with the accompanying drawings, in which:

FIG. 1 is a schematic exploded perspective view illustrating a variable phase shifter according to an embodiment of the present invention;

FIG. 2 is a plane structural view illustrating a fixed board among the variable phase shifter depicted in FIG. 1;

FIG. 3 is a plane structural view illustrating a rotating board among the variable phase shifter depicted in FIG. 1;

FIG. 4 is a detail perspective view illustrating the fixed board and the rotating board among the variable phase shifter depicted in FIG. 1;

FIG. 5 is an exemplary plane view illustrating a state in which the rotating board rotates on the fixed board in the variable phase shifter depicted in FIG. 1;

FIG. 6 is an exemplary plane view illustrating another state in which the rotating board rotates on the fixed board in the variable phase shifter depicted in FIG. 1; and

FIG. 7 is an exemplary plane view illustrating another state in which the rotating board rotates on the fixed board in the variable phase shifter depicted in FIG. 1.

### BEST MODE FOR CARRYING OUT THE INVENTION

A variable phase shifter, includes: a housing; a fixed board unit fixedly installed inside the housing, equipped with an input microstrip line with a via hole for receiving an input signal on one face thereof, and equipped with at least one circular arc-shaped output microstrip line outside the input microstrip line; and a rotating board unit rotatably installed inside the housing while being in contact with the one face of the fixed board unit, equipped with a transmission microstrip line on a face coming in contct with the one face of the fixed board unit, and for providing at least one output signal by making coupling even during rotation thereof.

### MODE FOR THE INVENTION

Hereinafter, exemplary embodiment of the present invention will be described with reference to the accompanying drawings. The next description includes particulars, such as specific configuration elements, which are only presented in support of more comprehensive understanding of the present invention, and it will be obvious to those of ordinary skill in the art that prescribed changes in form and modifications may be made to the particulars in the scope of the present invention. Further, in the following description of the present invention, a detailed description of known functions and configurations incorporated herein will be omitted when it may make the subject matter of the present invention rather unclear.

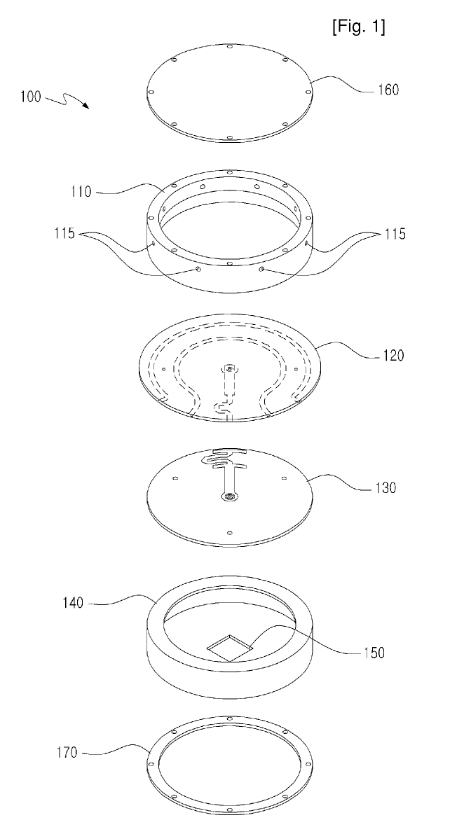

FIG. 1 is a schematic exploded perspective view illustrating a variable phase shifter according to an embodiment of the present invention.

With reference to FIG. 1, the variable phase shifter 100 according to an embodiment of the present invenion is equipped with a cylindrical housing 110 in which a proper receiving space is formed. A disc-shaped fixed board 120 and a disc-shaped rotating boarding 130 are installed in the cylindrical receiving space of the housing 110 in such a form that the fixed board 120 and the rotating boarding 130 come in contact with each other. Namely, the installation is implemented in such a structure that a lower face of the fixed board 120 and an upper face of the rotating board 130 come in contact with each other, and a thin insulating membrane, which is made depending on respective shapes of the fixed board and the rotating board 130, and which is, for example, manufactured by using a photo imageable solder mask conventionally used as a surface processing scheme of a board when a printed-circuit board is manufactured, is installed between the touching structure, so that a direct connection between the fixed board 120 and the rotating board 130 can be prevented.

Also, the fixed board 120 and the rotating board 130 merely come in contact with each other, and are not fixedly combined with each other. The above structure enables the fixed board 120 and the rotating board 130 to adhere to each other. Hereinafter, with the following structure, a face on the rotating board 130 coming in contact with the fixed board 120 can slide when the rotating board 130 rotates.

A rotating body 140 which rotates with the provision of turning force from the outside is arranged in the lower part of the rotating board 130, and is installed inside the housing 110. In an embodiment of the present invention, as a tetragonal connection groove 150 is formed in the lower part of the rotating body and then the rotating body is interlocked with an external motor (not shown), a rotatable configuration can be accomplished.

While the fixed board 120 is fixedly arranged properly inside the housing 110, the rotating board 130 is combined with the rotating body 140, and rotates with a rotation of the rotating body 140. At this time, the rotating body 140 and the rotating board 130 combined with the rotating body 140 are interlocked with each other to rotate with the connection groove 150 as the central axis.

In a state where the fixed board 120, the rotating board 130, the rotating body 140, and the like are arranged inside the housing 110, the variable phase shifter 100 having the above structure is equipped with an upper cover 160 and a lower cover 170 respectively combined at the upper side and the lower side of the housing 110, and therefore, supports internal structures.

Hereinafter, referring to the accompanying drawings, a more detailed description will be made of a structure and an operation of the fixed board 120 and the rotating board 130.

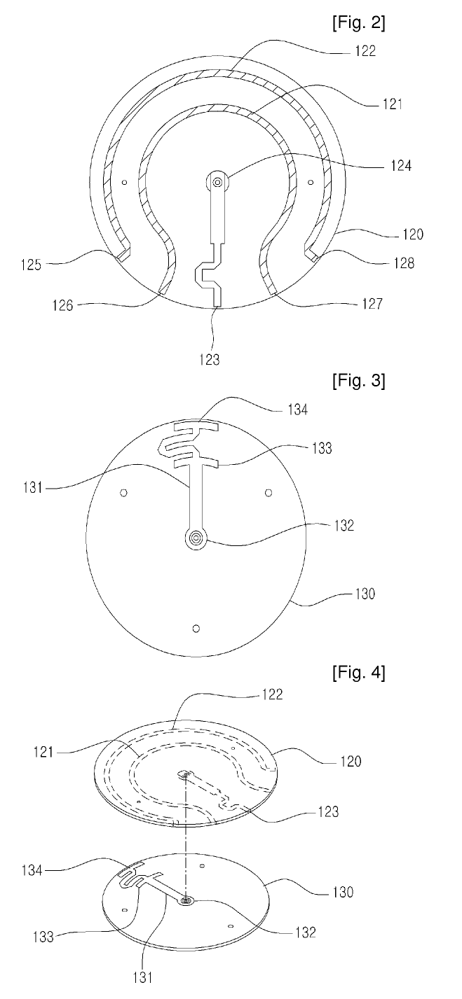

FIGS. 2 and 3 are plane structural views illustrating the fixed board and the rotating board among the variable phase shifter depicted in FIG. 1, respectively, and FIG. 4 is a detail perspective view illustrating the fixed board and the rotating board among the variable phase shifter depicted in FIG. 1.

With reference to FIGS. 2 to 4, first, the fixed board 120 includes a dielectric with a suitably set permittivity. In addition, the fixed board 120 is equipped with circular arc-shaped output microstrip lines 121 and 122 on an upper face of the fixed board 120. The first inside output microstrip line 121 and the second outside microstrip line 122 are concentrically arranged with the center of the fixed board 120 as the reference. Furthermore, a second and a third output ports 126 and 127 are formed at both circular arc-shaped ends of the first inside output microstrip line 121. A first and a fourth output ports 125 to 128 are formed at both circular arc-shaped ends of the second outside microstrip line 122. Herein, the first to the fourth output ports 125 to 128 are connected to connectors (not illustrated) which are respectively inserted into a set of through holes 115 formed in corresponding positions of the housing 110 illustrated in FIG. 1, and are then combined with the housing 110. Through the connectors, the first to the fourth output ports 125 to 128 are finally connected to each of radiating elements (not illustrated) of an antenna.

Also, on the upper face of the fixed board 120, an input microstrip line 123 is mounted, which is connected to any of the connectors respectively inserted into the set of through holes 115 formed in the corresponding positions of the housing 110, and then combined with the housing 110, is supplied with an input signal, and then delivers the input signal to a first via hole 124 formed in the central part of the fixed board 120.

Herein, an input port for being supplied with a signal from the outside is formed at the other end of the input microstrip line 123, and the signal input into the formed input port is provided to the rotating board 130, being coupled through the first via hole 124. In an embodiment of the present invention, the input microstrip line 123 of the fixed board 120 is illustrated to be a meander line form when it is viewed from the input port, but it goes without saying that the input microstrip line 123 thereof can have more various shapes.

Meanwhile, referring to FIGS. 3 and 4, the rotating board 130 is configured to include a transmission microstrip line. The rotating board 130 having this configuration has a structure in which the rotating board 130 adheres to the rotating body 140 while it rotates.

The transmission microstrip line 131 of the rotating board 130 is configured to have the structure of a meander line-shaped microstip line between a first opening part 133 and a second opening part 134. Namely, the rotating board 130 is embodied to have a disc shape, to come in contact with the lower face of the fixed board 120, and to have through holes formed in three proper positions with the central part of the rotating board 130 as the reference.

On the upper face thereof, the rotating board 130 is equipped with a second via hole 132 for being supplied with the input signal coupled through the first via hole 124 of the fixed board 120, and the first and the second opening parts 133 and 134 coupled to the output microstrip lines 121 and 122 of the fixed board 120 by means of capacitance. Also, the microstip line between the first and the second opening parts 133 and 134 is embodied in a meander line shape, and this meander line shape is arranged depending on length corresponding to a prescribed frequency.

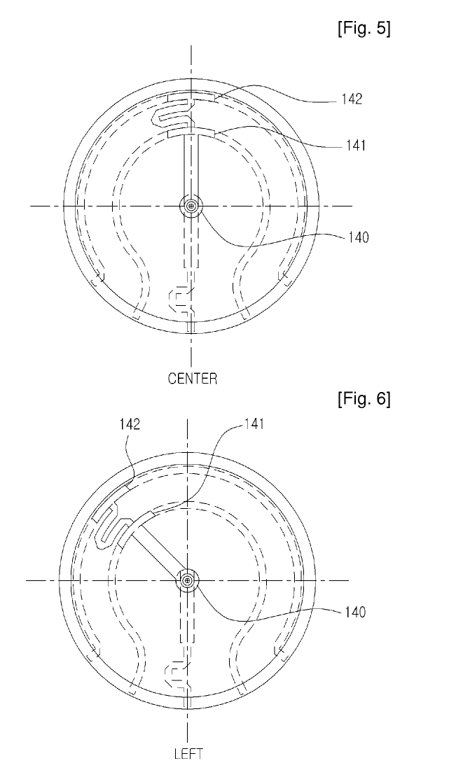

FIGS. 5, 6, and 7 are exemplary plane views respctively illustrating three different states in each of which the rotating board rotates on the fixed board in the variable phase shifter depicted in FIG. 1.

As illustrated in FIG. 5, the fixed board 120 has a structure in which a first and a second output microstrip lines are formed on a lower face of a dielectric board and then come in contact with the transmission microstrip line 131 formed in proper positions corresponding to the first and the second output microstrip lines 121 and 122 on the upper face of the rotating board 130. Accordingly, it can be perceived that the above structure corresponds to the structure of capacitance coupling betweeen microstrip lines.

Also, the first and the second opening parts 133 and 134 of the transmission microstrip line 131 in the rotating board 130 are arranged with the structure of coming in contact between the first and the second output microstrip lines 121 and 122 of the fixed board 120, and accordingly are rotatably configured.

The input microstrip line 123 of the fixed board 120 inputs a signal through the input port. Then, the input signal is coupled to a point where electromagnetic energy of the input microstrip line 123 meets the transmission microstrip line 131, i.e. a first transition point 140A, and is delivered to the transmission microstrip line 131 of the rotating board 130 by the input microstrip line 123 of the fixed board 120.

Thereafter, the distance between the first transition point 140A and the first and the second opening parts 133 and 134 of the transmission microstrip line 131 of the rotating board 130 is formed based on the wavelength of length corresponding to frequency contrast of a transmitted signal, and this configuration causes a transmitted signal to be delivered from the first transition point 140A to the first and the second opening parts 133 and 134 of the transmission microstrip line 131.

Through the above process, the input signal delivered to the first and the second opening parts 133 and 134 of the transmission microstrip line 131 is simultaneously coupled at a second transition point 141 and at a third transmition point 142.

Herein, the first and the second opening parts 133 and 134 of the transmission microstrip line 131 form an open end from a standpoint of circuitry. Also, a spot where electromagnetic energy of the transmission microstrip line 131 meets the first and the second output microstrip lines 121 and 122 corresponds to positions of the first and the second opening parts 133 and 134. Accordingly, the positions of the first and the second opening parts 133 and 134 are prepared so as to be placed in positions respectively corresponding to the circular arc parts of the first and the second output microstrip lines 121 and 122, and therefore, the electromagnetic energy of the transmission microstrip line 131 is radiated from the second and the third transition points 141 and 142, as illustrated in FIG. 5.

The signal to be delivered from the second transition point 141 of the above transmission microstrip line 131 is physically open, or is electrically short, and is then delivered to the first output microstrip line 121 of the fixed board 120. The signal delivered to the first output microstrip line 121 is distributed to both sides. The distributed signals in this manner are output through the second and the third output ports 126 and 127, and are then provided to the respective radiating elements (not illustrated) of the antenna.

Meanwhile, the signal delivered from the third transmition point 142 of the transmission microstrip line 131 is physically open, or is electrically short, and is then delivered to the econd output microstrip line 122 of the fixed board 120. The signal delivered to the second output microstrip line 122 is distributed to both sides. The distributed signals in this manner are output through the first and the fourth output ports 125 and 128, and are then provided to the respective radiating elements (not illustrated) of the antenna.

At this time, a state in which the rotating board 130 combined with the rotating body 140 rotates, i.e. based on the positions of the second and the third transition points 141 and 142 of the first and the the second opening parts 133 and 134 arranged on the upper face of the rotating board 140, depending on the rotation of the rotating board 130, a phase difference between the signals output through the first to the fourth output ports 125 to 128 is determined.

With reference to FIG. 6, if the second transition point 141 lies in a closer position to the second output port 126 than to the third output port 127, as a signal delivered from the second transition point 141 is distributed to the direction of the second and the third output ports 126 and 127, the length of a transmission line of a signal provided through the third output port 127 becomes longer than that of another signal provided through the second output port 126.

In this manner, as the lengths of transmission lines of signals distributed from the first output microstrip line 121 to the second and the third output ports 126 and 127 become different from one another, phase differences occur among the signals provided through the second and the third output ports 126 and 127.

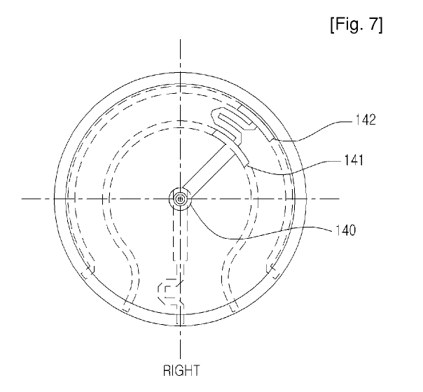

In the same manner, referring to FIG. 7, a signal delivered from the third transition point 142 is distributed to the first and the fourth output ports 125 and 128 of the second output microstrip line 122 with a phase difference therebetween, and then the distributed signals are provided from the first and the fourth output ports 125 and 128. If the third transition point 142 lies in a closer position to the fourth output port 128 than to the first output port 125, as the signal delivered from the third transition point 142 is distributed to the direction of the first and the fourth output ports 125 and 128, the length of a transmission line of a signal provided through the first output port 125 becomes longer than that of another signal provided through the fourth output port 128.

In this way, as the lengths of transmission lines of signals distributed from the second output microstrip line 122 to the first and the fourth output ports 125 and 128 become different from one another, phase differences occur among the signals provided through the first and the fourth output ports 125 and 128.

In the meantime, since the first and the second output microstrip lines 121 and 122 of the fixed board 120 are configured so as to have different line lengths from each other, the phase differences become different from one another among the signals provided through the second and the third output ports 126 and 127 of the first output microstrip line 121 and through the first and the fourth output ports 125 and 128 of the second output microstrip line 122.

For example, in a case where the phase difference between the signals provided from the second and the third output ports 126 and 127 of the first output microstrip line 121 is designed so as to be able to have the values ranging from ‘+1’ to ‘−1,’ the phase difference between the signals provided from the first and the fourth output ports 125 and 128 of the second output microstrip line 122 can be designed so as to be able to have the values ranging from ‘+2’ to ‘−2.’ Accordingly, the phase differences among the respective output ports 125, 126, 127, and 128 are set to ‘+2,’‘+1,’‘0,’‘−1,’ and ‘−2,’ thereby being able to change a tilt angle of a beam radiated through an antenna.

While the invention has been shown and described with reference to certain exemplary embodiments thereof, it will be understood by those skilled in the art that various changes in form and details may be made therein without departing from the spirit and scope of the invention. Therefore, the spirit and scope of the present invention must be defined not by described embodiments thereof but by the appended claims and equivalents of the appended claims.

### INDUSTRIAL APPLICABILITY

As described above, a variable phase shifter according to the present invention distributes an input signal through a microstrip line coupling structure using a fixed board and a rotating board, and by producing length differences among multiple transmission lines, varies phases among signals provided through output ports, thereby allowing a reduction in the overall product size of the variable phase shifter. In addition, mechanical abrasions caused by a mechanical contact between strip lines can be reduced, and a more improved performance of the variable phase shifter can be attained.

1. A variable phase shifter, comprising:
a housing;
a fixed board unit fixedly installed inside the housing, equipped with an input microstrip line with a via hole for receiving an input signal on one face thereof, and equipped with at least one circular arc-shaped output microstrip line outside the input microstrip line; and
a rotating board unit rotatably installed inside the housing while being in contact with the one face of the fixed board unit, equipped with a transmission microstrip line on a face coming in contct with the one face of the fixed board unit, and for providing at least one output signal by making coupling even during rotation thereof.

2. The variable phase shifter as claimed in claim 1, wherein the transmission microstrip line is coupled from the via hole of the input microstrip line.

3. The variable phase shifter as claimed in claim 2, wherein the transmission microstrip line is equipped with an opening part, and is arranged with a different length, depending on frequencies.

4. The variable phase shifter as claimed in claim 3, wherein the output microstrip line whose coupling is implemented from the opening part of the transmission microstrip line provides at least one output signal.

5. The variable phase shifter as claimed in claim 1, wherein an insulating membrane made depending on respective shapes of the fixed board unit and the rotating board unit is arranged between a face of the fixed board unit and a face of the rotating board unit, both of which come in contact with each other.

6. A variable phase shifter, comprising:
a housing;
a fixed board unit fixedly installed inside the housing, equipped with an input microstrip line with a via hole on one face thereof, and comprising a dielectric board equipped with two output microstrip lines all having circular arc shape and facing with each other outside the input microstrip line;
a rotating board unit rotatably installed inside the housing while being in contact with the one face of the fixed board, and equipped with a transmission microstrip line on a face coming in contct with the one face of the fixed board; and
an insulating membrane made depending on respective shapes of the fixed board and the rotating board, and arranged between a face of the fixed board unit and a face of the rotating board unit, both of which come in contact with each other; and
a rotating body for combining with the rotating board, and for rotating the rotating board by turning force provided from the outside,
wherein the two output microstrip lines for coming in contact with the transmission microstrip line even during rotation thereof provide respective output signals.

7. The variable phase shifter as claimed in claim 6, wherein wherein the transmission microstrip line is coupled from the via hole of the input microstrip line.

8. The variable phase shifter as claimed in claim 6 or 7, wherein the transmission microstrip line is equipped with an opening part at one end, and is arranged with a different length, depending on frequencies.
